(19) United States
(12) Patent Application Publication
(10) Pub. No.: US 2004/0046502 A1
(43) Pub. Date: Mar. 11, 2004

(54) Environment proof treatment for electro-luminescent (EL) element(s)

(76) Inventor: Tseng-Lu Chien, Taipei Hseng (TW)

Correspondence Address: BACON & THOMAS, PLLC, 625 SLATERS LANE, FOURTH FLOOR, ALEXANDRIA, VA, 22314

(21) Appl. No.: 10/621,513

(22) Filed: Jul. 18, 2003

Related U.S. Application Data
(63) Continuation-in-part of application No. 10/170,584, filed on Jun. 14, 2002.
(63) Continuation-in-part of application No. 10/285,451, filed on Nov. 1, 2002.
(63) Continuation-in-part of application No. 10/286,820, filed on Nov. 4, 2002.

(51) Int. Cl. H01J 1/62

(52) U.S. Cl. 313/512

(57) ABSTRACT

One or more electro-luminescent elements are sealed within an weather-proof plastic resin having optical properties to protect and enhance the appearance of the electro-luminescent element(s).

This application is a continuation-in-part of U.S. patent appliation Ser. No. 10/170,584, filed Jun. 14, 2002 and Ser. No. 10/285,451, filed Nov. 4, 2002 and Ser. No. 10/286,820, filed Nov. 4, 2002.

### BACKGROUND

The current invention relates to EL-element(s) may including panel, tube, strip which are arrangements for consumer applications such as those involving a Shoe, Slide, Slipper, Sandal, Automobiles, Boat, Bus, Aircraft, Garden, Traffic Equipment, Bag, Purse, House, Building, Christmas, Seasonal, Bicycle, Tricycle, Toy, Moving Device, Skating, Jogging, Watch, Garment, Apparel, Clothing, Jeans, Box, Tool Box, Working Lamp, Furniture, Giftware, Headgear, Jewelry, Hair Accessories, Partyware, Sign, Indoor lighting, Outdoor lighting, Street Lamp, Guide lamp, Bridge lamp, Traffic Cone, New Jersey Deck, Fence, Mail Box, House Number Light, Window Sign, Wall Sign, Poster, Pathway, Stair, Curb, Line divider for People, Evacuation light, Fishing Marker, Decoration Device for Safety, Decorating, Advertisement, Promotion, Point-Of-Purchase, Warning Light, Accent Light, Illumination light, Floor light, Delineator Guide Light, Evacuation light, Night light, Multiple Function Light, Portable light(s) which can be found in the market place with other light means such as L.E.D./Incandescent light bulb/fluorescent tube, Neon Tube, HID lamp etc.

The current invention uses EL-elements having sufficient light brightness with very low power consumption as described in the current inventor's variety of issued US patents including U.S. Pat. Nos. 5,746,504, 5,980,060, 5,722,760, 5,504,397, 5,475,574, 5,479,325, 5,570,946, 5,469,342, 5,570,945, 5,704,705, 5,611,621, 5,860,727, 5,865,523, 5,879,069, 5,572,817, 5,752,337, 5,794,366, 5,833,508, 5,688,038, 5,871,269, 5,720,651, 5,806,960, 5,947,980, 5,775,016, 5,566,384, 5,876,108, 5,836,671, 5,601,358, 5,754,064, 5,921,653, 5,667,394, 6,082,867, 6,170,958, 6,183,101, 6,171,117, 5,926,440, 6,158,868, 6,182,282, 6,179,431, 5,599,088, 5,213,616, 6,169,431, 6,280,053, 6,170,958, 6,168,282, 5,926,440, 5,683,164, 6,183,101, 6,123,616, 6,280,053, 5,926,440, 5,754,064, 5,879,069 and other issued patents owned by current inventor.

The advantage of using electro-luminescent (EL) lighting elements in a variety of contexts are explained in several co-pending US patent applications including U.S. patent application Ser. Nos. 08/305,294; 08/343,404; 08/343,915; 08/383,404; 08/383,405; 08/409,925; 08/421,647; 08/432,707; 08/438,373; 08/444,064; 08/436,007; 08/489,160; 08/498,258; 08/510,701; 08/522,940; 08/561,973; 08/611,049; 08/614,001; 08/522,940; 08/712,484; 08/734,872 which cover more uses for an electro-luminescent (EL) element(s).

All listed inventions and conventional market applications can not make fully environment-proof which means can not overcome Ultra-Violet, Humility, Moisture, Electric-Shortage to cause the light lost designed functions. Hence, the co-pending filing for weather-proof treatment which is improvement for the Moisture, Humility problems to said elements. The current invention to solve following problems including:

1. Sealed the EL-elements by plastic resins process may selected by injection, pouring, curing procedure by conventional plastic resin material may selected from group material from PC, PP, PS, PE, PVC, PU, PET, POLY, Silicone, or any chemical resins or particles or liquid with proper procedure to make the EL-element(s) been sealed inside to make environment-proof properties.

2. Incorporating the Optics Theory may including the Reflective, Retro-Reflective, Random Reflective, Magnify Image, Reduce Image, Focus Arrangement, Total Reflective, Diffusion, Filter, Radiation theory and all technical which related to the material transparency, finesses of surface, angle of light beams traveling, Material Thickness, Material Color to make the electro-luminescent (EL) element(s) in geometric shape(s) can have eye-catching effects for visual viewing.

3. Further improvement the circuit technical for desired functions may be in group combinations selected from fade in and out, chasing, sequential, pair flashing, scan, pause, on and off interval to meet market requirement.

4. Further, The current invention may incorporated with other light means may selected from conventional market available light source such as LED, HID, Bulb, Fluorescent, Cold-Cathode tube, Violet tube, Bulb Tube light, LOD, to make the desired combination light to meet market requirement.

5. The current invention also create a workable sealing incorporating with co-pending patents' concept to use a center buss-wires as the electric-signal(s) delivery with super lowest electric-resistance to deliver to as far as possible by connect each electro-luminescent (EL) element electrode to one of the buss-wires. The each element's electrode connected with one of buss-wires, this can up to desired numbers of element's electrodes to buss-wires as market requirement. The preferred and simple examples are as FIG. 5 with all details discussion later.

These improvements can let the electro-Luminescent (EL) element(s) sealed inside the plastic resin(s) by pre-determined procedure incorporated the optics theory with Desired transparency, Color material, Fineness surface by polishing process, Shape of material for creating desired Image effects, Thickness of Material to form the Image result, Element(s) geometric shapes with variety of light emitting and traveling path so can create desire light effects for all devices with super environment-proof quality. Further more incorporated with 2^{nd} light means will make more attractive light effects than consumer's expectation.

Basing on these (5) Major features and improvement, the current invention solves the environment problem that has held-up widespread acceptance of electro-luminescent elements for the past two decades.

### FIGURE

FIG. 1: Disclosure the 1^{st} embodiment which electro-luminescent (EL) element(s) in a preferred twisted tube shape and sealed inside of the plastic resin(s) by injection procedure for footwear application.

FIG. 2A: Disclosure the 2nd embodiment for the details arrangement to seal twisted electro-luminescent (EL) elements inside the plastic Piece.

FIG. 2B: Disclosure the 3rd embodiment for details of arrangement to seal the plurality of flat shaped electro-luminescent (EL) elements inside the plastic Piece with Optics properties on the Piece for making the light image changed.

FIG. 2C: Disclosure the 4th of embodiment for arrangement to seal the flat strip of electro-luminescent (EL) element into plastic Piece with light emitting direction to thickness with loop follow the contour of the piece with variety of number of optics ditch on the proper locations.

FIG. 2D: Disclosure the 5th of embodiment for arrangement to seal the one electro-luminescent (EL) element in geometric shape and the connection-area also sealed into the plastic Piece only electric-wires exposed in the air.

FIG. 2E: Disclosure the 6th of embodiment for arrangement to seal the plurality of electro-luminescent (EL) elements in the fork-shaped which have desired pitch-distance of each lit-area and have one area having all the elements' electrodes to connect with the conductive-means to get electric signals.

FIG. 3. Disclosure the procedure for multiple procedures to seal the said element(s) inside the desired plastic resin(s) material, further more the procedure included to add the heat-transfer film which offer the simple procedure to add the artwork, color, indicia, designs on the plastic Piece within seconds while apply the 2^{nd} injection process.

FIGS. 4A-4D: Disclosure the preferred embodiment for the optics arrangement for the plastic Piece to make visual effects with desired light effects including to use plastic material thickness, transparency properties of plastic material, finesses plastic piece, Convex or Concave design, Added other material into Chemical to get diffusion effects. It also disclosure the Silkscreen(s), Masking(s), Window(s), Stencil(s), Cut-Out(s), Opening(s) apply to the Plastic piece related to the EL-element(s) lit-areas positioned to get desired effects.

FIG. 4D: Disclosure the procedure for sealing procedures of preferred embodiment for micro-injection applications which use Pouring process not by injection machine. It also disclosure the Stitching-edge for contour so can easily added on any application's surface.

FIG. 5: Disclosure the details application for electro-luminescent (EL) element(s) sealed inside Plastic Piece and the method to connect with a plurality of number of such sealed Electro-luminescent (EL) element(s) into desired length, loop, linear, configuration, path, route by variety of shaped connectors which make desired linear arrangement.

### DETAIL DESCRIPTION

The environment proof treatment for the geometric designs or shape of Electro-Luminescent element(s) means to seal the said element(s) inside the plastic resin(s) by injection process or the preferred and equivalent of method may including the pouring, hand-operation such process to get the said EL-element(s) been sealed properly.

The plastic resin(s) or particle(s) are individual pieces and will become a single piece after the resin(s), particle(s) been treated under certain temperature, pressure, heating, timing though the tooling. Well control the all these factors to meet the electro-luminescent (EL)-element(s) properties can seal the said elements within the plastic piece with designed light brightness, appearance, viewing effects and overcome the environment damage may caused by nature or the human forces including the humility, water, temperature, violet ray, impact strength, bending, deforming, pulling, broken, heat, stitching, and so on all reasons to cause the said element(s) lost its designed function(s), light output(s), brightness, color(s).

The preferred procedure for high efficiency and less labor by the injection machine to make this sealing. The tooling for this plastic injection may be designed to hold the EL-elements well before injection and make one injection process to make nice and good sealing. This procedure and tooling design basing on the preferred purpose for different application and not discuss because easily to do from conventional market. Properly control the injection timing, temperature, pressure and selected the plastic resin(s) to match the EL-element(s) properties will make good injection to see EL-elements within the plastic piece. Alternative way to prevent from loose of one-time injection, the injection procedure can become multiple steps for examples to make 1^{st} injection piece with pre-designed groove(s), ditch(s), Shallow Area(s) and install the geometric element(s) inside the groove(s), ditch(s), shallow area(s) to make the 2^{nd} times injections procedure to seal the EL-elements.

Further more, the injection procedure can be plurality of times to inject by machine or human operation to make the desired result such as Micro-Injection Application which use a tooling and use multiple different color resin(s), liquid Chemical materials to inject into all the shallow areas(s), groove(s), ditch(s) so the procedures are more than two times injection method. Basing the liquid chemical for the micro-injection procedure so the sealing technical not limited for the Plastic resin(s), particle(s) but also means including all the different construction of the plastic in solid or liquid forms.

This have variety choice from market place may selected of PC, PP, PVC, PE, PS, Acrylic, PET, PU, Rubber, Silicone,

which are refine from the oil procedure or its related material such as Rubber from trees, oil from ancient animal under ground which may consider to apply for this invention. It also can be covered for Chemical or Plastic resin(s), Particle(s), liquid(s) to make the same material join together by its Chemical properties.

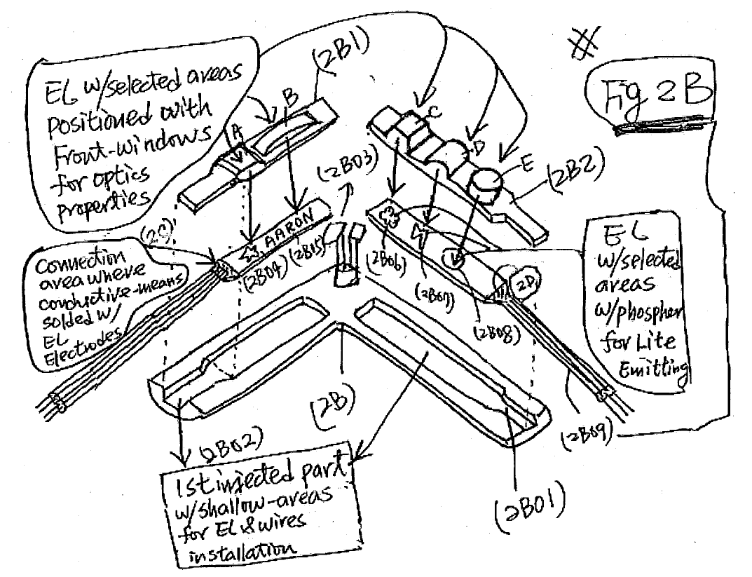

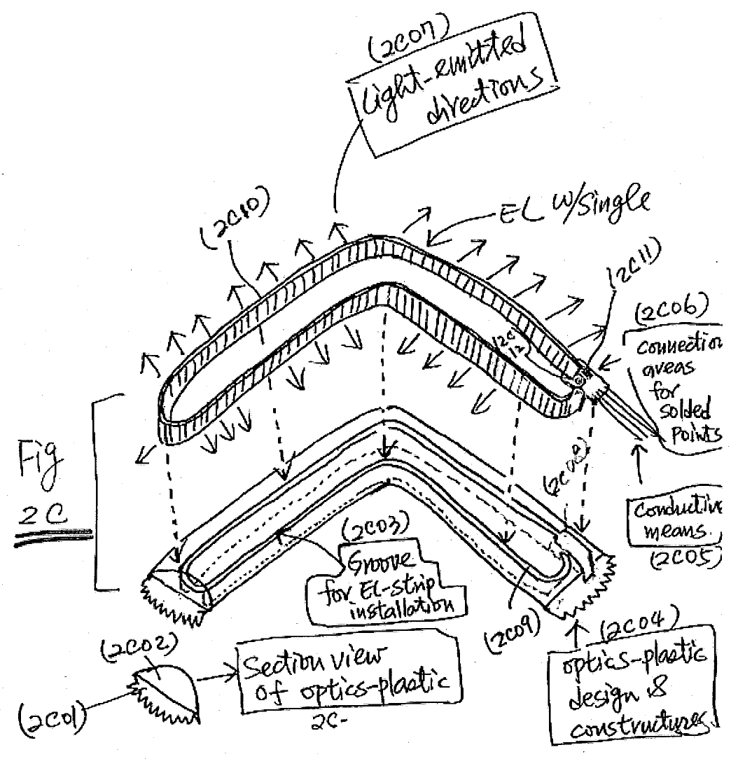

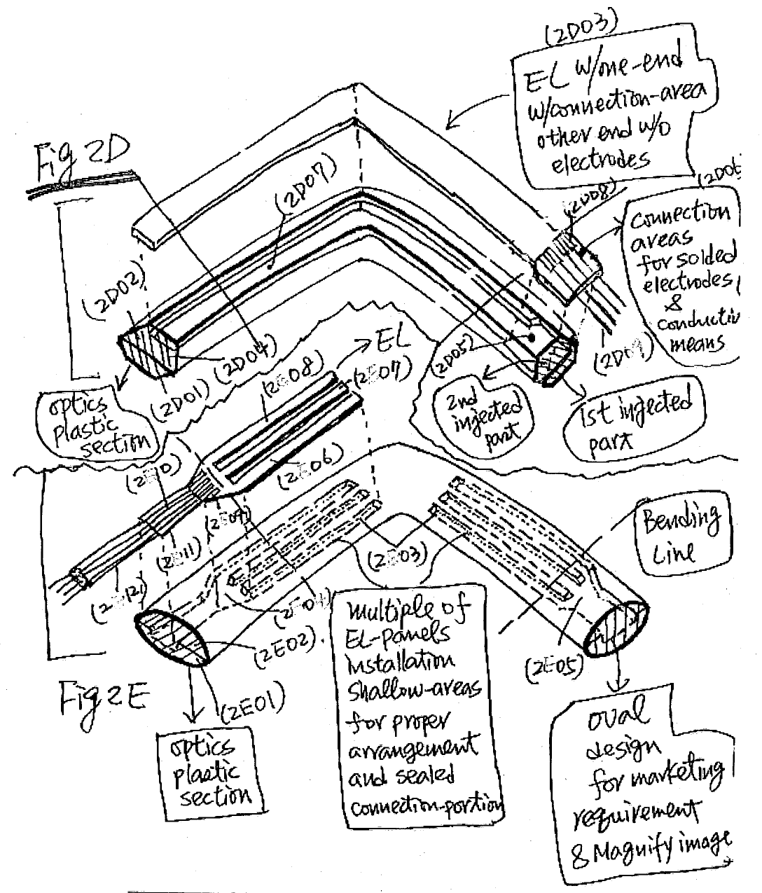

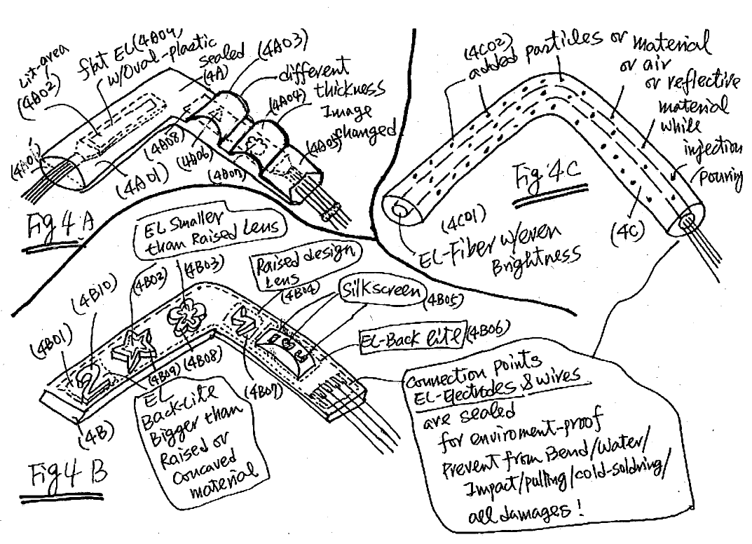

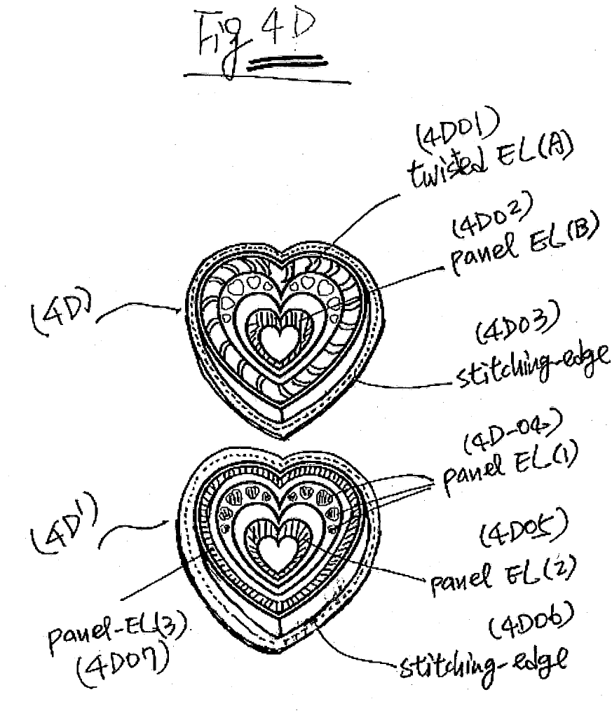

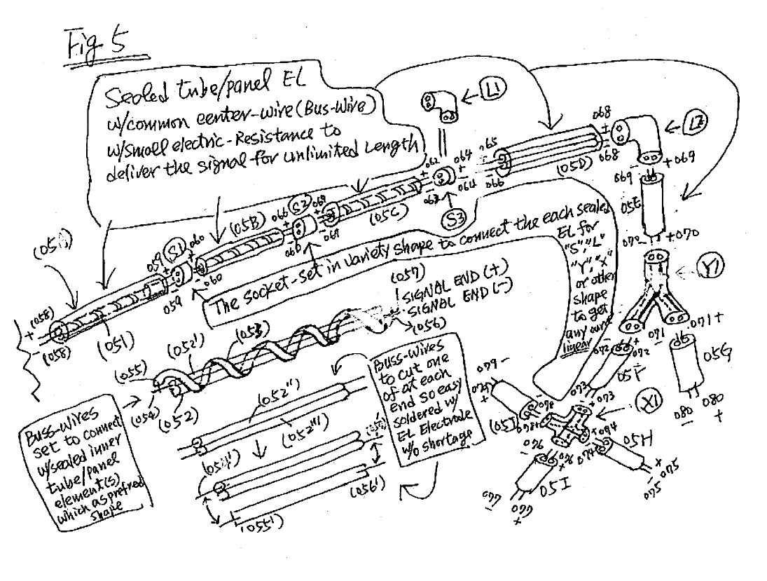

The each electro-luminescent EL-element(s) have its output-end(s) in the form of the area(s) including the Common-electrode and desired positive electrode(s). The conventional for negative or common electrode which preferred as the ITO layer to make this common electrode. The conventional market preferred to use Silver paste to make connection with different lit-area(s) phosphor to form the Positive electrode (Lit-area(s)'s electrodes). All these electrodes of the said element(s) can be connected with metal terminals, flexible Printed Circuit (FPC) by means including punch, contact, or conventional available method to build the signal(s) delivery. Such connection points may be sealed inside the plastic Piece or outside the Plastic Piece basing on the different application so this may be described as partial sealed or optional selected sealed within or outside the plastic Piece. There have a lot of consideration basing on different requirement for different applications. The EL-element(s) also an be pretreated as the twisted EL panel tube light as co-pending filing, From FIG. (1) can see the twisted tube EL-element(s) are sealed inside plastic but this is pre-twisted so allow EL-element(s) can sealed inside a “L” shaped plastic Piece. As for the Panel, Sheet, Strips for “L” Shape bending, A preferred method is to let the light within the Plastic Piece on proper orientation as FIG. 2C. This can incorporated with other optics theory to make light be visible with excellent result as FIG. 4A, FIG. 4B, FIG. 4C.

The light effects of said element(s) can be make visual result while proper sealed by plastic piece from the resin(s), particles(s), liquid(s) with prefer designed Thickness of plastic material (FIGS. 4A, 4B, 4C), Fineness of surface (not shown), Transparency of Material, Diffusion grade, Diffusion material added (FIG. 4C), other particle(s) added, Shape of the

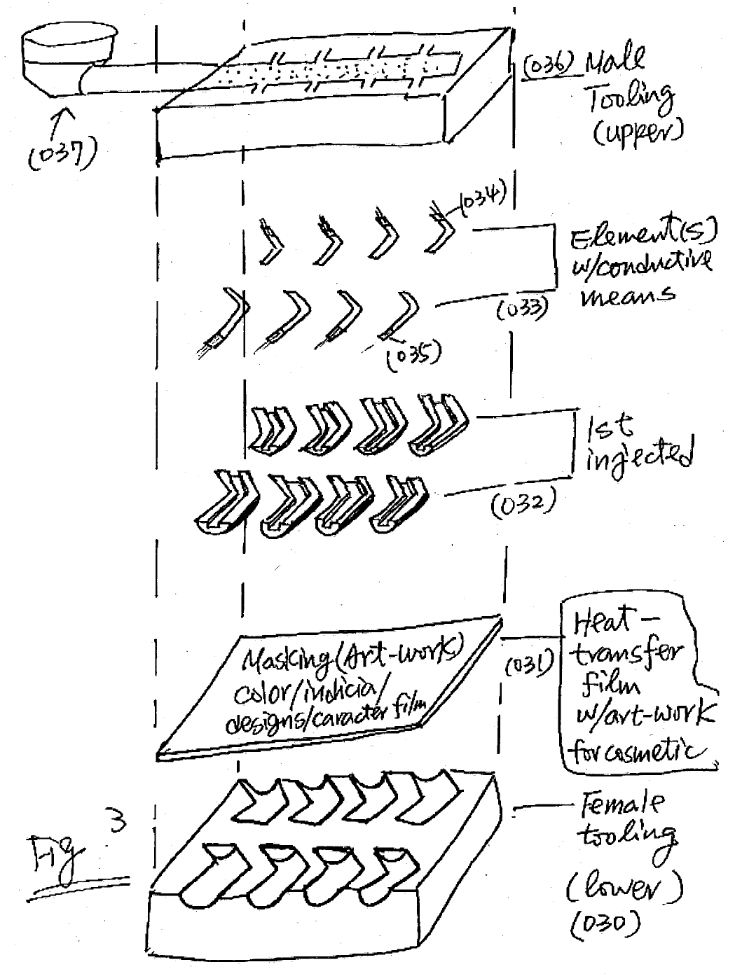

Plastic piece as normal other light means treatment. Most important is all sealing procedure have to match the EL-element(s) properties including the EL-element(s) deforming temperature, ink properties, phosphor properties, lamination properties, tightness of lamination, minimum bending radius and all other factors which will cause the EL-element(s) been damaged by the sealing processes. The said visual result which means including the light beams be seen with image, size, brightness, clearance, color, direction are different with the said element(s) not been sealed. Incorporated with co-inventor's earlier patented concept for positioned the said element(s) with front window(s), cut-out(s), Silkscreen area(s). The current invention can also have all these treatments on the plastic surface to make desired light effects with indicia(s), Character(s), design(s), art-work(s) be lit for some advertisement purpose. This can get from simple tooling designs (FIG. 3), masking (FIG. 3), stencil, silkscreen printing (FIG. 4B), plastic Piece's surface treatment from conventional market technical. Further more, the transfer ink film also can add on injection machine so can add the Plastic-Piece's surface with desired appearance while use this conventional technical for simple masking procedure with color and design, indicia.

It also can add some other material or particles (FIG. 4C) such as Small metal piece, metal powders, particles within the chemical's resin(s), particle(s), liquid(s) to mixed together and get some diffusion objects inside the plastic piece so the light beam will be reflective to all direction to cause more splendid light effects for viewer.

The incorporated other light-means may including the conventional available light means from LED, Bulb, Organic electro-Luminescent, Organic LED, LOD which is powered by batteries which can supply enough life time for the applications. While sealed together with the said element(s) will have other taste and visual effects.

This is the big improvement for the environment of the said element(s) and other light means for certain applications.

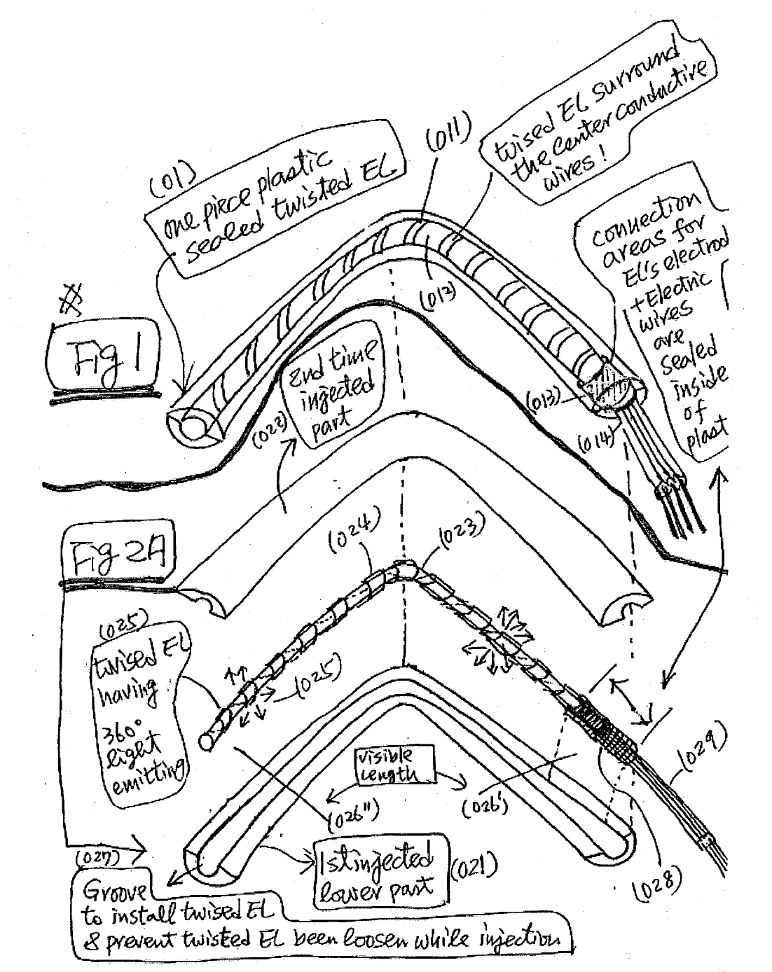

From FIG. 1: Disclosure the twisted element(s) sealed inside Plastic-Piece (01). The twisted EL-element (011) has details description of co-pending filed on Ser. Nos. 10/170,874 and 10/285,451 and 10/286,820. The twisted element (011) are twisted surround the center electric-wire(s)(012) with the electrodes (not shown) connected with center electric-wire(s) (011) and outside electric-wire(s) (014) though desired method including Clamp-Terminal (not shown) which are punched though the EL-element(s) electrode(s) and hold so can allow soldering process. This is one preferred method, The alternative way can have the Flexible Printing Circuit (FPC) which are use the Silver Paste to glue, curing with electro-Luminescent element(s) electrode so can apply soldering procedure. It also can use the Printing Conductive material such as Silver Paste only but it having higher electric resistance for this arrangement. To build the EL-element's electrode(s) with electric wire(s) have a lot of alternative method from convention market which not limited to this preferred embodiment discussion but still inside current invention coverage. From the FIG. (1), the EL-element(s) electrode(s) are connected with electric wire(s) (012) (014) to build the electric Signal(s) delivery. This connection-area (013) with durable electric connection and sealed by shrink-tube or hot-glue, silicone, epoxy, tape, paper tape to hold all connection-area(s) well. The Connection-area (013) is the weak area for whole EL-element(s) application especially for the waterproof requirement so the current invention solved this because this connection-area (013) is sealed inside the Plastic-Piece well.

From FIG. 2A, The Plastic-Piece (021) is injected at earlier time and with a grove (027) which to allow the twisted EL-element (024) to well install within the groove (027) because the groove (027) is little smaller than twisted EL-element (024) for diameter so can fit into groove very tight and prevent from the twisted EL-element (024) deform the shape and become the loosen construction.

The EL-element (024) are twisted surrounded the center Buss-wires (023) which offer the electric-signal(s) with very low electric-resistance so can supply expected electric-signals with sufficient power to turn on the EL-element(s) for super brightness. The Center Buss-wire(s) (025) connected with EL-element electrode. It also have the outside conductive-means (029) connected with EL-element other electrode so build the electric-circuit to make light with function(s).

The Twisted EL-element (024) has light emitting outward to cover the 360 degree so the light output as super value neon light. After the twisted EL-element (024) and its connection-area (028) well installed and put into injection machine to make the 2^{nd} injection to allow the 2^{nd} injected part (022) join with the 1^{st} injected part (021) without any gap, hole so can have environment grade quality to prevent from the humility, water, bending, impact to cause the EL-element or connection-area been damaged.

From FIG. 2B, The 1^{st} injected part (2B) have two shallow areas (2B01) and (2B02) which allow the two piece of Flat EL-Elements on the shallow areas. The Each EL-element has its selected lit-areas (2B04), (2B05), (2B06), (2B07), (2B08) which has the phosphor coated on these location and positioned with 2^{nd} injection part's related areas (A), (B), (C), (D), (E) which each area has the different optics lens design such as (A) is a square raised lens positioned with lower Star lit-areas, (B) is raised shaped lens to positioned lower AARON lit-areas, (C) is rectangular raised lens positioned with lower FLOWER lit-area, (D) is round raised lens positioned with lower THUNDERBOLT lit-area, (E) is a cylinder raised lens positioned lower ROUND lit-area. The 2^{nd} injection piece with certain location with window(s) positioned with lower EL-element's lit-areas. This is current inventor 's early issued patents U.S. Pat. Nos. 5,572,817, 5,794,366, 5,752,337, 5,833,508 so we do not discuss here with details. The connection-area (2C) and (2D) also install on the shallow areas (2B02) and (2B01) sealed by 2^{nd} injection so all these most weak areas are also sealed and get well protection.

From FIG. 2C, the 1^{st} injection plastic-part (2C01) with teeth ditches to create desired light effect(s). The 2^{nd} injection part (2C02) is smooth radius surface so can let people have comfortable wearing while this device apply to the sandal. The 1^{st} injection part (2C01) has the groove for EL-element in strip form (2C10) can easily install. The EL-element (2C10) with light emit outward as AAROW shown. The preferred arrangement is make the EL-element has the loop to follow the contour of the injection plastic-piece with the wider shallow area (2C08) to allow EL-element's connection-area (2C06) can Install well. The two EL-element's electrodes (2C11) and (2C12) connected with outside conductive-means (2C05) sealed well within the shallow area (2C08) so can be sealed after 2^{nd} injection applied to the 1^{st} injection part.

From FIG. 2D, the 1^{st} injected-part (2D01) have a shallow area (2D07) to install the EL-element (2D03). The wider shallow area (2DO5) to install the connection-area (2D06) including the EL-element's 4 electrodes, 4 soldered points, 4 outside conductive-means which have pre-sealed by shrink-tube. The 1^{st} injected part (2D01) has the geometric shape to allow the light emitting outside with desired viewing angle. Same as the 2^{nd} injected part (2D02) has the optics designs.

From FIG. 2E, the 1^{st} injected part (2E01) and 2^{nd} injected part (2E02) with convex lens design to let the light image become bigger basing on the optics theory. The 1^{st} injected part (2E01) has shallow-areas (2E03) to allow install EL-element which have the fork design with 3 lit-areas (2E06) (2E07) (2E08) with pitch-distance to make special design and colors. The wider shallow-areas (2E04) (2E05) are allow the connection-area to fit well within the plastic-piece. The Connection-area have the 4 EL-element's electrodes (2E09) and 4 outside connective-means (2E10) and 4 soldered points (not shown) are sealed within the shrink-tube (2E11). The flat EL-element does not have the center buss-wires which existing for the Twisted EL-element as FIG. (1) and FIG. (2A).

From FIG. 3, the 1^{st} injected part (032) have plurality of number and pre-install EL-elements (033) into the 1^{st} injected part (032). The conductive-means (034) outside the plastic-piece after the 2^{nd} injection is done. The one masking film is added before the 2^{nd} injection. The film is heat-transfer film which can use the predetermined temperature, pressure by machine operation to transfer the artwork, indicia, color, characters, design to plastic-piece's surface. This will make the light transmitting, traveling plastic-piece's will be much good appearance under this simple process. This also may incorporated with current inventor's Issued patent U.S. Pat. No. 5,572,817 as above listed. The surface of plastic-piece (032) cosmetic may also created by add the extra particles, resins, powders, ink, colors or equivalent material(s) to cause the light transmit with visual change effects. The simple method is add the extra materials inside the injection material input tank (037) after the well mixed with plastic-piece original materials.

From FIG. 4A, the plastic-part (4A) have the two radius parts (4A01) and (4A01′). The plastic-part (4A) sealed two sheets of EL-Elements (4A08) and (4A09), each of the EL-element has desired lit-areas including lit area (4A02) of EL-element (4A09). The lit-areas (4A06) and (4A07) are for EL-element (4A08).

The each lit-area have positioned with the certain window to get the desired light optics properties such as the lit-area (4A06) positioned with window (4A03) which is a convex lens. The lit-area (4A07) of flower are positioned with window (4A04) which is a convex and raised lens for magnify optics properties. The lit-area (4A02′) is positioned with the convex lens (4A01′) for whole EL-element's lit-area.

From the FIG. 4B show the V-shaped EL-element (4B) which has plurality of lit-areas (4B01), (4B02), (4B03), (4B04), (4B06) are positioned with upper windows with different treatment including 2-shaped raised lens (4B10) related the backlight (4B01). The star-shaped raised lens' window (4B09) is positioned with lower lit-area (4B02). The flower shaped lens' window (4B08) is positioned with the lower lit-area (4B03). The thunderbolt-shaped window (4B04) is positioned lower lit-area in the shape of backlight design. The Silkscreen printed window (I) (heart-shape) (U) of plastic-piece may be alternative treatment including cut-outs, masking, stencil, heat-transfer art work, raised lens in front of the lower backlight function's lit-area.

From the FIG. 4C, the added particles, materials, reflective pieces can let the light transmitting channel to change and make diffusion light effects. The Plastic-piece (4C) has EL-element inside with light emitting to outward. The Plastic-piece has mixed the other particles, material (4C02) to make the inner light beams' pathway changed to make special light effects.

From the FIG. 4D, The heart shape micro-injection piece (4D) (4D′) both have the windows to allow the light can pass though from the areas (4D01) (4D02) (4D04) (4D05), (4D07). Each window has the lit-area to positioned and with different color and different light effects as required. The Both Heart-Shaped Micro-Injection piece are made by human labor to injected the liquid material in to the different groove with some areas (4D01) (4D02) (4D04) (4D05), (4D07) with light passing though. Both has the stitching edge (4D03) and (4D06) for stitching purpose to any main objects too.

From the FIG. 5, The EL-element (05A) is sealed inside the plastic-piece with two inner buss-wires having incorporated with two of the conductive-means (058+) and (058−) on both ends. The Pin-type conductive means (058+) and (058−) can easily to connected with socket set's receptacles (059+) (059−) respectively. The electric-signal from the (058+) though the buss-wire inside the plastic-piece to the end (059+) is same electric signal just with tiny difference basing on the electric resistance by buss-wire material. No any big voltage, frequency, current change because the buss-wire have sufficient amount of signals can offer to plurality of EL-elements to connect to desired length. The 1^{st} (05A) till the last (05I) will have same brightness because each EL-elements only drain less current from Buss-Wire because all EL-elements are hook with buss-wire by parallel connection as long as the Buss-wire can carry enough signals (Currents) and well design of the specification, then, this will solve the other ELAM (Israel-U.S. Pat. No. 5,485,355) limited current carrier of its outer coil electric-pole. Even current inventor has related utility patent right U.S. Pat. Nos. 6,270,229 and 6,082,867. Hence, The current invention use the center buss-wire(s) to delivery the current (Signals) and all EL-elements are in-parallel connected with center buss-wire(s) can make big improvement for connected unlimited number of EL-elements to designed length, configuration, loop, linear path for indoor and outdoor application is the other purpose.

From FIG. 5, The Buss-wire(s) have conductive-means (058+) and (058−) expose to the air. The current carried from the (058+) and (059−) traveled the (05A) buss-wires to the other end have the conductive-means (059+) and (059−) respectively. The voltage, current, frequency measured at the two ends of EL-Element (05A) is almost same with limited tiny changes basing on buss-wire(s) internal electric-resistance.

The outside conductive-means (059+) and (059−) connected with Receptacle (S1) to connected with EL-element's (05B) outside conductive-means (060+) and (060−) respectively. The electric signals traveled the EL-element (05B) to the other end's conductive-means (066+) and (066−). The Measurement for the current voltage, frequency, current will keep almost same from the conductive means as this simple path: (058+)→(05A)→(059+)→(S1)→(060+)→(05B)→(066+)−−>(S2)→(067+)→(05C)→(062+)→(S3)→(064+)→(065+)→(068+)→(069+)→(070+)→(071+)→(072+)→(07 3+)→(073+)→(074+)→(076+)→(077+). This means the electric current with voltage, frequency, current amount by mini-amperage do only tiny changed from the start point to the application end. This is big improvement for the conventional Christmas light string, Israel (ELAM) EL wires. Same as the negative current while travel path as above listed.

The EL-element within the individual unit such as (05A), (05B), (05C), (05D), (05E), (05F), (05G), (05H), (05I), (05J) have the EL-element (053) is twisted surrounded the center buss-wires (052) and (052′) incorporated the preferred receptacle-means to become well construction device which can connect with outside signals ends or the other device to desired length, configuration, shapes for market requirement. The EL-element's electrode (055) is connected with buss-wire (054) by soldered on terminals which are punched though and clamp on the electrodes. The terminal is one of conductive means it can be any shape as long as it is conductive for electricity. The individual device which have the EL-element with Plastic sealing and receptacle-means can install for any application such as garden light, fish tank, balloon or other applications, utilities. The receptacle-means can main purpose is offer a receptacle to receive the EL-element's exploded conductive-means, or to offer a attachment-means to apply to application or utility. The receptacle-means can have multiple-ends to receive plurality of exposed EL-element's conductive means. It also can have attachment-means on the certain location to offer install on main-objects so can allow the individual device to join with mian-object for desired construction and device is a light means with receptacle as base or as attachment-means.

The EL-element's others electrode (056) is connected with buss-wire (057) by soldered. The buss-wires (052′) and (052″) have two ends with electric-wire outside the plastic skin. In order to make the good arrangement, the buss wires (052′) and (052″) may ask wire factory offer as the wire with pre-cutted arrangement as (054′) and (057′) so there is no any risk for soldering work with EL-element electrode (055′) and (056′) without the shortage issues.

From receptacle (S1), (S2), (S3), (S4), (L1), (L2), (Y1), (X1) with desired designs and construction which needed to meet the requirement to fit all kind of linear curvature, curvilinear, loop, path for universal to fit for variety application. The receptacle should be have all kinds of shape may similar with the Plumping, Bulb tube light set etc. However, the current invention offer an environment sealing process for EL-element(s) with durable quality to against the bend, scratch, water, humility, impact force, ultra-violet ray, pull, twist, press, punch so can have good quality. The Receptacle shape may select from the “L”, “S”, “Y”, “T”, “X” type to allow the EL-elements in tube construction can be assembled into any linear curvature requirement. These list shapes are preferred embodiments not the limitation the scope of the current invention.

Although preferred embodiments of the invention have been described in details. It will be appreciated that the scope of the invention is not to be limited to the described embodiments, but rather that the invention is to be interpreted in accordance with the appended claims.

1. The Electro-Luminescent element(s) with Plastic sealing incorporated:
At least one electro-luminescent element(s) having desired light output(s), color(s), brightness, designs, in geometric form with predetermined conductive mean(s) are properly sealed inside the single Piece.
The improvement:
The said sealing means the said element(s) are sealed with chemical resin(s), particle(s), liquid(s) under desired temperature, pressure, timing, tooling, heat, operation(s) to make the said resin(s), particle(s), liquid(s) from variety measured-units into one piece and the said element(s) sealed inside the said Piece with selected operation(s).
Further more, the said element(s) have different light viewing result after the said sealing, while the said element(s) connected with circuit and power source.
The said the viewing result may have Image, Color, Brightness, Clearance, Size, light emitting direction, Change(s) from viewer eye.
The conductive means may in a wire, ribbon, Flexible printed circuit board (FPC), electrodes of the said element(s) with preferred sealed to allow the said element(s) to connected with the said circuit and power source to get desired light function(s) and feature(s).

2. The Electro-Luminescent element(s) with Plastic Sealing as claim 1, the said operation may selected from group combination from injection by machine or human Pouring process with desired times to get the best result.

3. The Electro-Luminescent element(s) with plastic sealing as claim 1, the said Electro-Luminescent elements selected from sheet, panel, twisted, bended, folded, cylindered, coil and preferred form(s) install inside of the said Piece.

4. The Electro-Luminescent element(s) with plastic sealing as claim 1, further incorporated with Piece with desired thickness, transparency, color, other added material to allow the image, size, brightness, color, with viewing difference while connected with signal(s).

5. The Electro-Luminescent element(s) with plastic sealing as claim 1, The Chemical means is one material which come from refine procedure from the Oil, Tree, Animal into Plastic, Rubber, PVC, PE, PP, PU, POLY, PC, PS in particle, resin, liquid form to allow people to make Light transmission allowance material.

6. The Electro-Luminescent element(s) with plastic sealing as claim 1, further incorporated other light means for more features.

7. The Electro-Luminescent element(s) with Plastic sealing as claim 1, the said plastic Piece have treatment(s) apply to the surface to make windows, designs, masking, cut-out(s), opening(s), lamination(s), Silkscreen, in-mold film, heat-transfer indicia, thickness changed where can positioned the said element(s) lit-areas and make light emitting out to viewer be seen.

8. A Electro-Luminescent element(s) with Plastic sealing incorporating:
At least one Electro-luminescent element(s) twisted surround the center buss-wire(s) which deliver the predetermined electric signal(s) with desired voltage, frequency, current amperage from the one end to other ends.
The buss-wire(s) connect with electrode(s) of element respectively to supply the signal(s) to drive element(s) for desired light function(s).
A conductive-means apply to connect with buss-wire(s) with proper sealing to connect with outside signal(s) source.

9. The Electro-Luminescent element(s) with Plastic sealing as claim 8, further incorporating preferred receptacle-means to become a well construction's device which can connect with outside signal(s) source or the other devices or utilities.

10. The Electro-Luminescent element(s) with Plastic sealing as claim 9, the device with preferred receptacle-means to connected with plurality of the said sealed Electro-Luminescent element(s) devices where all the said devices in-series connection, in-parallel connection, or any combination of the in-series and in-parallel connection for desired application(s).
